(19) United States
(12) Patent Application Publication
(10) Pub. No.: US 2006/0010692 A1
(43) Pub. Date: Jan. 19, 2006

(54) Scissors split into two kitchen knives

(76) Inventor: Feng-Hsia Kuan Huo, Chung Ho City (TW)

Correspondence Address: Leong C. Lei, PMB#1008, 1867 Ygnacio Valley Rd., Walnut Creek, CA, 94598, US

(21) Appl. No.: 10/892,105

(22) Filed: Jul. 16, 2004

(51) Int. Cl. B26B 13/28

(52) U.S. Cl. 30/122; 30/254

(57) ABSTRACT

A pair of scissors and kitchen knives in one, comprised of two blades pivoted to each other; a blade each on the single side of the back of the edge of the first and the second blades at where both blades facing each other; the heels of both blades secured by a bow holder and a ring holder; another heel of the first blade overlapped with an angular plate of the second blade; a pivot axis on the second blade; a lateral bolt provided to the pivot axis; and an axial bore on the first blade to enter into or leave from the lateral bolt.

### BACKGROUND OF THE INVENTION

(a) Technical Field of the Invention

The present invention is related to a pair of scissors, and more particularly, to one that can be split into two kitchen knives.

(b) Description of the Prior Art

Scissors and kitchen knives are a must in the kitchen to cut off the sealing bags of the edibles or to prepare cooking materials. However, the exchangeability between the scissors and the kitchen knife is unlikely since the kitchen knife is not so handy to cut off a plastic bag. Therefore, both of the scissors and a bunch of kitchen knives must be available by the sink; and one has often to search for a pair of scissors or a kitchen knife.

### SUMMARY OF THE INVENTION

The primary purpose of the present invention is to provide a pair of scissors that can be split into two separate kitchen knives. One of the knives can also operate as a can opener and both respectively are handy for a right-handed or a left-handed user. To achieve the purpose, the scissors of the present invention is comprised of a first blade and a second blade overlapped and pivoted to each other. A cutting edge is provided on one side of each blade and both cutting edges are facing each other. Another heel extends from the distal end of a heel of the first blade. An angular plate is formed on the distal end of a heel of the second blade. The extended heel of the first blade is overlapped with the angular plate on the heel of the second blade. The heel of the second blade is strayed away at a certain inclination from the angular plate and protrudes beyond the heel of the first blade. The heel of the second blade is inserted into and secured in a ring handle, and the heel of the first blade is inserted into and secured in a bow handle. The bow handle strays away from a line extending from the cutting edge of the first blade.

A pivot axis provided vertically at its end a lateral bolt is disposed on the second blade at where the second blade is to be pivoted. An axial bore is provided on the first blade at where in relation to the pivot axis and the axial bore enters into or leaves from the lateral bolt at a given crisscrossing angle. With such a movable pivot mechanism, the pair of scissors can be split into two separate kitchen knives. Whereas both of the scissors and two kitchen knives share the same two blades, the user has two cutting tools in one piece without bothering to search for a pair of scissors or a kitchen knife.

Another purpose of the present invention is to provide a pair of scissors that can be split into two separate kitchen knives that also operate as a can opener. To achieve the purpose, a gap is formed on the cutting edge of the first blade. Accordingly, when the pair of the scissors is split into two kitchen knives, the first blade can also operate as a can opener.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIG. 2 is a schematic view showing a first blade of the preferred embodiment of the present invention is turned over.

FIG. 3 is a schematic view showing a second blade of the preferred embodiment of the present invention is turned over.

FIG. 4 is a sectional view taken from IV-IV in FIG. 1.

FIG. 5 is a sectional view taken from V-V in FIG. 1.

FIG. 6 is an exploded view of the preferred embodiment of the present invention.

FIG. 7 is a schematic view showing an application of the preferred embodiment of the present invention.

FIG. 8 is a schematic view showing another application of the preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

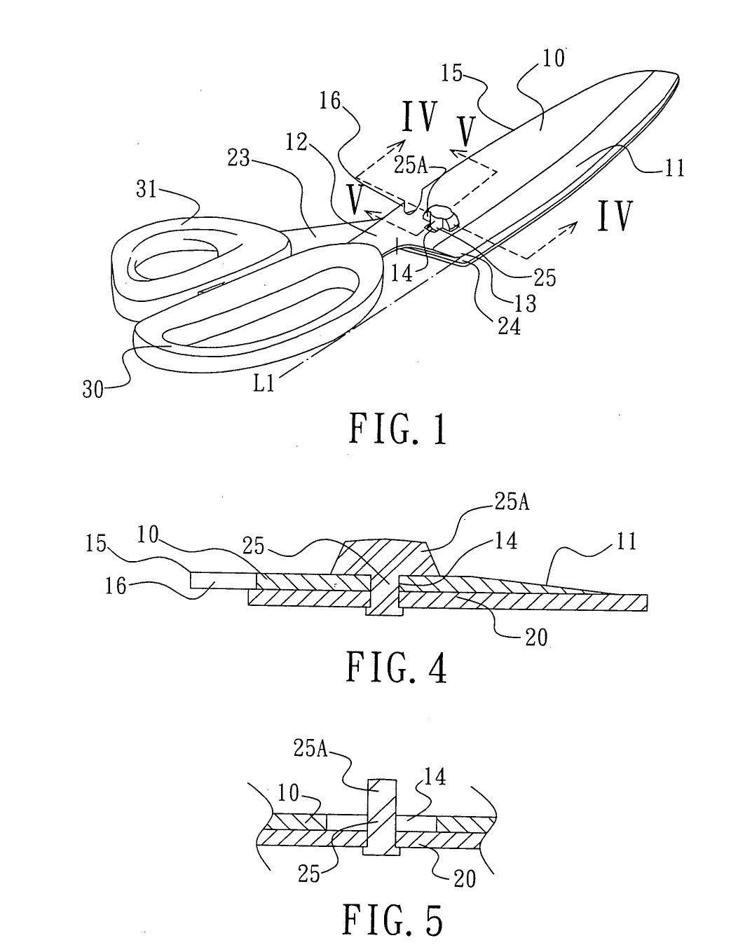

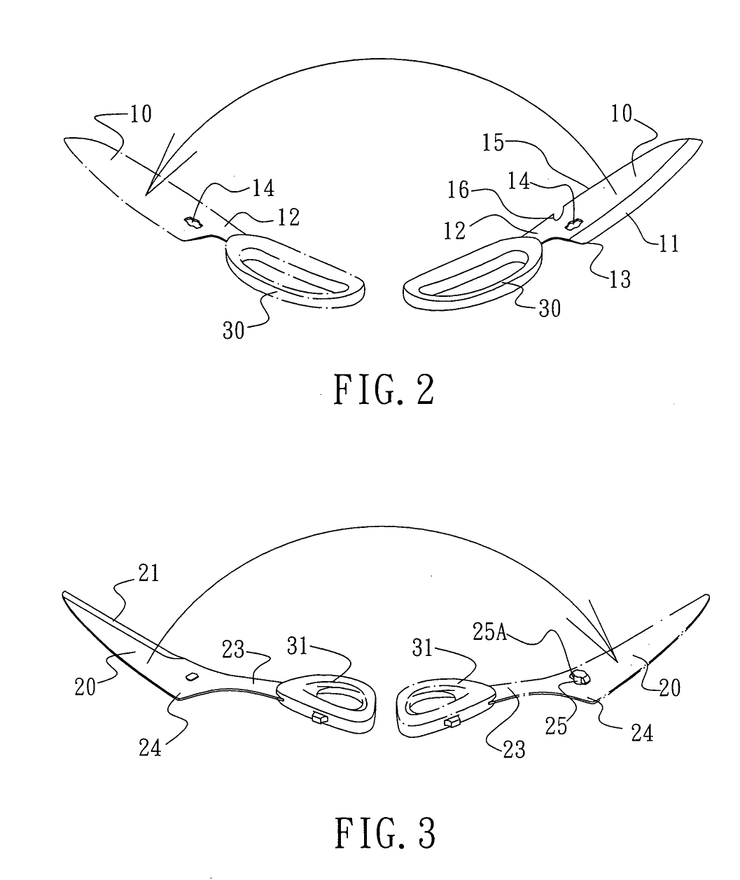

Referring to FIG. 1 for a perspective view of a pair of scissors of the present invention, FIG. 2 for a schematic view showing the process of turning over a first blade, and FIG. 3 for a schematic view showing the process of turning over a second blade; wherein, the pair of scissors of the present invention that can be broken down into two kitchen knives is comprised of a first blade 10 and a second blade 20 with both overlapped and pivoted to each other. At where both blades 10, 20 clamping against each other, a cutting edge 11 (21) is formed at a certain inclination on one side on the back of the first blade 10 (20). Another heel 13 extends from the distal end of the cutting edge 11 on the first blade 10 at where close to a hell 12 while an angular plate 24 to be overlapped with the heel 13is formed on the distal end of the blade back 22 of the second blade 20 at where close to a heel 23. The heel 23 of the second blade 20 is strayed away at a certain inclination from the angular plate 24 and protrudes beyond the heel 12 of the first blade 10. Similar to a pair of sewing scissors, a bow handle 30 and a loop ring handle 31 are provided to the scissors of the present invention. The heel 23 of the second blade 20 is inserted into and secured by the ring handle 31. The heel 12 of the first blade 10 is inserted into and secured by the bow handle 30 with the bow handle 30 located at where strays away from a line L1 extending from the cutting edge of the first blade 10.

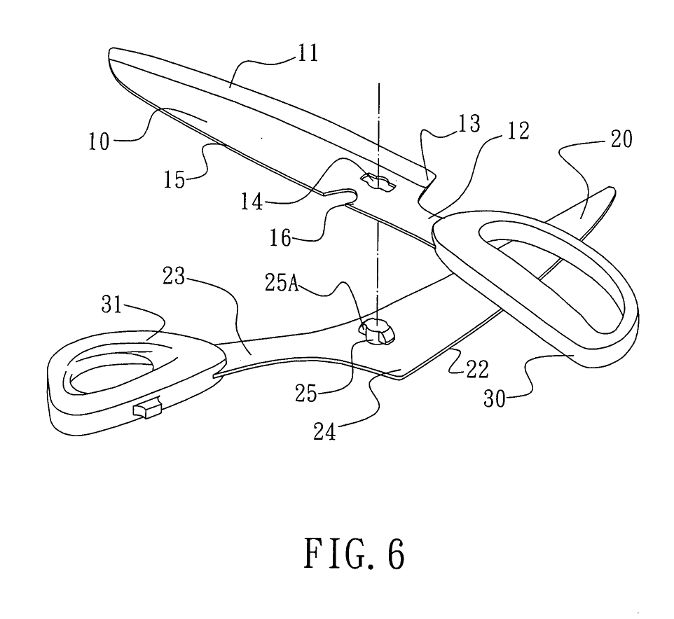

As illustrated in FIGS. 4 and 5 for the sectional views of the present invention, a pivot axis 25 having at its end provided with a lateral bolt 25A is disposed vertically on the second blade 20 at where the pivot is preset. An axial bore 14 is disposed on the first blade 10 at where in relation to the pivot axis 25A to merely enter or leave the lateral bolt 25A at a given crisscrossing angle. It is to be noted here that the angle is greater than that to open up the scissors to prevent slip. The crisscrossing angle is preferred to such extent when closing upon both of the first and the second blades (10, 20). The lateral bolt 25A is vertically provided to the extended length of the axial bore 14. The pivot axis 25 may be integrated with the second blade 20 or inserted through a locking pin provided at where the second blade 20 is pivoted. By means of pivoting to the movable mechanism, the first blade 10 and the second blade 20 are tightly clamped and overlapped to each other to operate as a pair of scissors. Meanwhile, as illustrated in FIG. 6, the first blade 10 is disengaged from the second blade 20 by having one hand to hold the bow handle 30 and another hand to hold the ring handle 31 to spread up both blades 10, 20 to where the contour of the lateral bolt 25A and that of the axial bore 14 are matched to respectively pull up and down both blades 10, 20. Both blades 10, 20 are now available as two separate kitchen knives. Furthermore, a gap 16 is disposed on the cutting edge of the first blade 10 for a can opener.

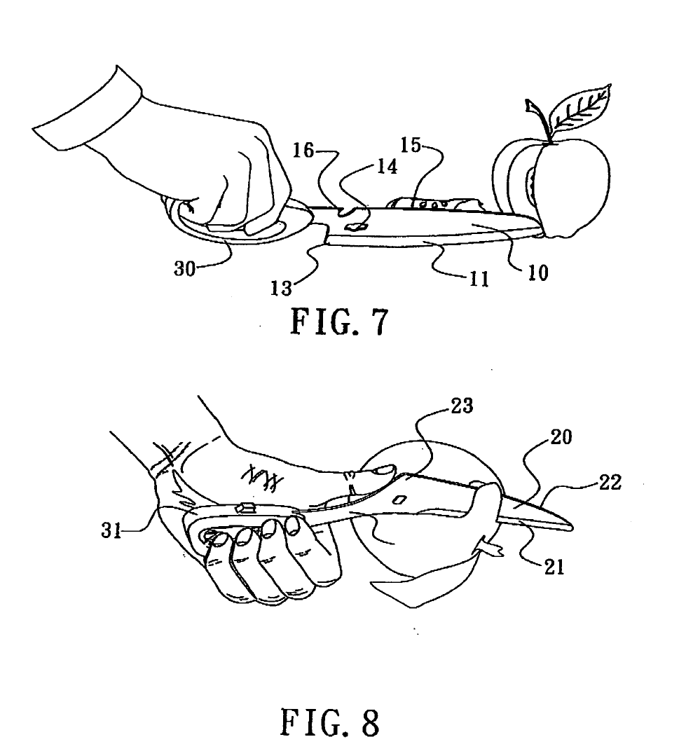

For a right-handed user as illustrated in FIG. 7, he may hold with his right hand the bow handle 30 of the first blade 10 to use the cutting edge 11 as a kitchen knife, or he may turn over the blade 10 to open a can by engaging the gap 16 to the edge of the can. Alternatively as illustrated in FIG. 8, a left-handed user may hold the ring handle 31 of the second blade 20 to use the cutting edge 21 as a kitchen knife to skin something.

The present invention by providing a pair of scissors that can be split into two kitchen knives saves the trouble of searching for the scissors or the kitchen knife, simplifies the design of having both of the scissors and kitchen knives combined n one piece, and has not yet been made available in the market to comply with the requirements of patent law. Therefore this application for a utility patent is duly filed accordingly.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-12. (canceled)

13. A pair of scissors capable of converting into two kitchen knives, comprising: a first blade and a second blade overlapped and pivoted to each other; a cutting edge being each provided on one side of said blades facing to each other; said first blade having a first heel and a second heel; the first heel protruding from a proximate end of said cutting edge of said first blade where close to said second heel; an angular portion being formed on a proximate distal end of a blade back of said second blade and being overlapped with said first heel of said first blade; said second blade having a third heel straying away at an inclination from said angular portion and protruding beyond said first heel of said first blade; said third heel of said second blade being inserted and secured in a ring handle; said second heel of said first blade being inserted and secured in a bow handle; said bow handle straying away from a line extending from said cutting edge of said first blade; a pivot axis having an end provided with a lateral bolt arranged vertically on said second blade and integrally formed with said second blade, an axial bore provided on said first blade and configured to receive said pivot axis, said axial bore being configured to merely enter or leave said lateral bolt at a given crisscrossing angle, said crisscrossing angle being greater than a crisscrossing angle of said blades which are opened up to operate as a pair of scissors, wherein a gap is formed on said first blade at where close to said second heel to function as a can opener.
